(19) United States
(12) Patent Application Publication
(10) Pub. No.: US 2010/0193564 A1
(43) Pub. Date: Aug. 5, 2010

(54) Adjustable Handle for Pneumatic Fastener

(75) Inventors: John E. Buck, Cockeysville, MD (US); Michael Kunz, Hampstead, MD (US); John Castelino, Perry Hall, MD (US); Glen V. Steinbrunner, Bel Air, MD (US); Jorge Silveira, Abingdon, MD (US); David C. Boyle, Severna Park, MD (US); Mahdi Chowdhury, Fayetteville, NC (US)

Correspondence Address: THE BLACK & DECKER CORPORATION, 701 EAST JOPPA ROAD, TW199, TOWSON, MD, 21286, US

(73) Assignee: BLACK & DECKER INC., Newark, DE (US)

(21) Appl. No.: 12/699,135

(22) Filed: Feb. 3, 2010

Related U.S. Application Data
(60) Provisional application No. 61/149,589, filed on Feb. 3, 2009.

(51) Int. Cl. B25F 5/02; B25C 1/04; B25C 7/00

(52) U.S. Cl. 227/130; 227/120; 227/156

(57) ABSTRACT

An apparatus and method for adjusting the handle position of a pneumatic fastener handle. The pneumatic fastener includes a base, a main body, and a magazine for carrying fastening members. The main body and magazine are fixed to the base. A pneumatic inlet is mounted onto the main body. A handle assembly is mounted on the main body of the pneumatic fastener. The handle assembly includes a housing having a hollow recessed area. The housing can have an aperture through a lateral side configured to receive a retaining member. A handle extends partially within the housing and is configured to move between at least a first position and a second position, different from the first position. When the handle is in a desired position, the retaining member secures the handle in place within the housing.

### CROSS-REFERENCE TO RELATED APPLICATIONS

The present application claims priority to U.S. Patent Application No. 61/149,589 entitled Adjustable Handle for a Pneumatic Nailer, filed Feb. 3, 2009, which is incorporated herein by reference in its entirety.

### TECHNICAL FIELD

This application relates to a handle for use with a pneumatic fastener.

### BACKGROUND OF THE INVENTION

1. Field of the Invention

The present invention relates generally to the field of power tools, and particularly, to an adjustable handle for a pneumatic fastener such as a flooring nailer.

2. Description of the Related Art

Pneumatic power tools are commonly employed in a variety of work places to accomplish a diverse assortment of tasks. Typical pneumatic power tools include pneumatic fasteners such as pneumatic nailers. These pneumatic fasteners often employ piston assemblies coupled to valve assemblies to provide the force desired to drive a fastener into a surface.

Unfortunately, application of these tools in a diversity of spacing conditions or for different sized users is limited because of the fixed length of power tool handle. For example, most flooring nailers have handles that are fixed in length to the main body of the nailer. As such, using the flooring nailer in a confined area is difficult if not impossible without making manual adjustments to the nailer. For example, some users remove the handle from the flooring nailer and use a shorter makeshift implement as a handle. In addition, users of a certain height, either taller or shorter than average, are challenged because of the failure of many current flooring nailers to be ergonomically sensitive.

It is desirable to provide an apparatus and method that permits a power tool such as a flooring nailer to have an adjustable handle that provides flexibility of use in confined or open locations and for users having different heights.

### SUMMARY OF THE INVENTION

This application relates to an apparatus and method for adjusting the handle of a pneumatic tool having standard components, e.g., a main body, magazine, and base. The apparatus and method disclosed herein allow users to effectively and comfortably position the flooring nailer in a variety of applications and in a variety of conditions.

The present invention is directed to a handle assembly for a pneumatic fastener. The pneumatic fastener has a base, a main body, and a magazine for carrying fastening members. Both the main body and the magazine are fixed to the base. A pneumatic inlet permits pressurized air into the main body. The handle assembly is adjustable and includes a housing having a hollow recessed area. The housing has at least one side that is configured to receive a retaining member such as a screw. A handle is operatively configured to be movable and secured within the housing. Thus, the handle can be adjusted between at least a first position and a second position, different from the first position.

Advantages include at least the following: more reliable use of the handle on pneumatic fasteners, comfort, and ease of use for the user, and the ability for the pneumatic fastener to be used in confined spaces where a fixed full-length handle is not feasible. A shortenable handle also allows users to increase the speed for setting the tool in a desired position compared to tools with a fixed full-length handle. Other advantages and features will be apparent from the description, the drawings, and the claims.

### BRIEF DESCRIPTION OF THE DRAWINGS

The numerous advantages of the present invention may be better understood by those skilled in the art by reference to the accompanying figures. In the drawings, like reference numerals designate corresponding parts throughout the several views.

FIGS. 1A and 1B illustrate a pneumatic fastener having a handle assembly according to a first embodiment of the present invention, including a locking pin and detent adjustable handle;

FIGS. 2A-2E illustrate a pneumatic fastener having a handle assembly according to a second embodiment of the present invention, including a push button locking pin with pivot arm;

FIGS. 3A and 3B illustrate a pneumatic fastener having a handle assembly according to a third embodiment of the present invention, including a screw-in fastening knob;

FIGS. 4A and 4B illustrate a pneumatic fastener having a handle assembly according to a fourth embodiment of the present invention, including a sliding handle and clamping lever;

FIGS. 5A and 5B illustrate a pneumatic fastener having a handle assembly according to a fifth embodiment of the present invention, including a rotating jack screw and handle with set screw;

FIGS. 6A and 6B illustrate a pneumatic fastener having a handle assembly according to a sixth embodiment of the present invention, including a twist locking collet adjustable handle;

FIGS. 7A-7C illustrate a pneumatic fastener having a handle assembly according to a seventh embodiment of the present invention, including a quarter turn locking adjustable handle;

FIGS. 8A and 8B illustrate a pneumatic fastener having a handle assembly according to an eighth embodiment of the present invention, including a spring loaded pull-out locking knob and pin;

FIGS. 9A-9C illustrate a pneumatic fastener having a handle assembly according to a ninth embodiment of the present invention, including a telescoping handle with locking screw;

FIGS. 10A-10D illustrate a pneumatic fastener having a handle assembly according to a tenth embodiment of the present invention, including a removable modular handle insert; and

FIGS. 11A and 11B illustrate a pneumatic fastener having a handle assembly according to an eleventh embodiment of the present invention, including vertical frame rails and a sliding handle.

### DETAILED DESCRIPTION OF THE INVENTION

Reference will now be made in detail to the presently preferred embodiments of the invention, examples of which are illustrated in the accompanying drawings.

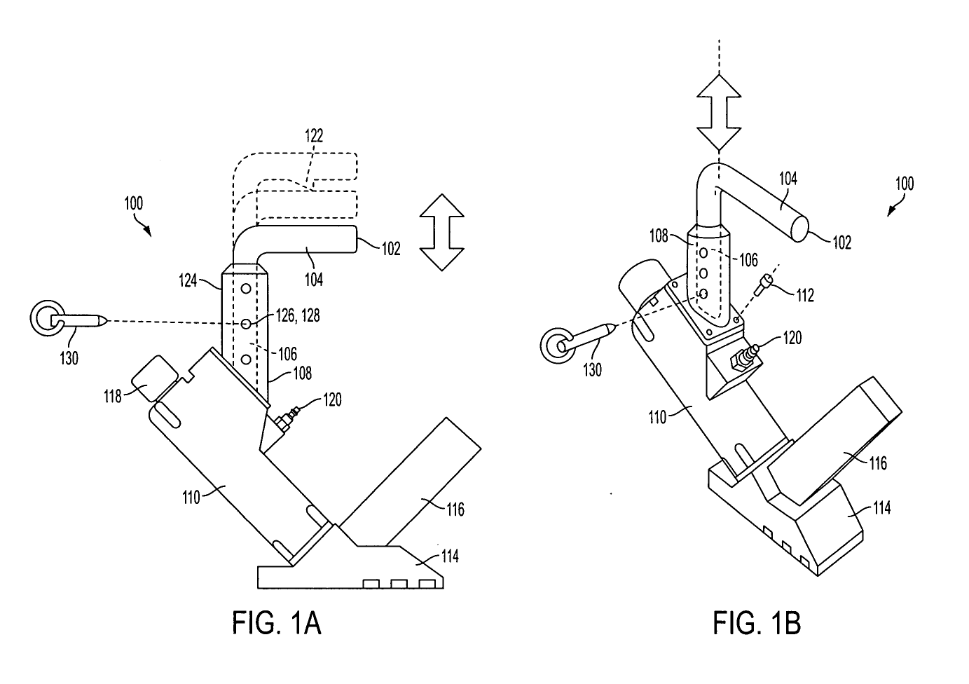

In an exemplary embodiment of the present invention as shown in FIGS. 1A and 1B, the pneumatic fastener 100 includes a handle assembly including a handle 102 and a securing mechanism 130 for securing the handle to the pneumatic fastener. The handle 102 has an upper portion 104 and a lower portion 106. A housing 108 is coupled to the lower portion 106 of the handle 102 and is mounted on an upper surface of a main body 110. The housing 108 can be secured to the main body 110 by fastening members such as, for example, screws 112. The main body 110 is coupled to a base 114 for positioning the pneumatic fastener with respect to an article to be fastened. Also coupled to the base 114 is a fastener magazine 116, for carrying a plurality of nails or cleats to the main body 110. The main body 110 has a first end provided with a striking plunger 118 and a second end provided with nail outlet designed to eject the nail from the magazine 116 when the striking plunger is struck. The striking plunger 118 forms part of the driving mechanism, which is also located within the main body, for driving a fastener into a workpiece. An optional trigger 122 is pivotally attached to the handle for activating the driving mechanism. The handle 102 further includes a pneumatic air fitting 120, which enables the coupling of a compressed air supply to the pneumatic fastener 100.

Referring now to FIGS. 1A and 1B, in an exemplary embodiment, the housing 108 defines a hollow recessed area 124 within which the lower portion 106 of the handle 102 is disposed. The lower portion 106 of the handle 102 is coaxially slidable within the recessed area 124 of the housing 108. As shown in the figures, the housing can have, for example, a generally cylindrical shape. The housing has at least one aperture 126 through at least one side of the housing 108. A plurality of housing apertures can be vertically arranged, relative to the main body 110. Handle apertures 128 are also formed through at least one side of the lower portion 106 of the handle 102. In operation, the handle 102 of the pneumatic fastener can be adjusted by sliding the handle toward and away from the main body 110. The handle 102 can be secured to the housing 108 by aligning at least one of the apertures 126 of the housing with at least one of the apertures 128 in the lower portion 106 of the handle 102. A securing member such as a locking pin 130 can be inserted through the aperture 126 in the housing 108 and then into the aperture 128 in the lower portion 106 of the handle 102 to fix the handle in place, thereby preventing the handle from rotating or sliding with respect to the housing. For example, as shown in FIG. 1A, apertures 128 in the lower portion 106 of the handle 102 are vertically arranged, so that the handle can be adjusted to different lengths. Thus, for a short handle arrangement, the upper portion 104 of the handle 102 is closest to the main body 110 or the lowermost handle aperture 128 is aligned with the housing aperture 126, or lowermost housing aperture. Alternatively, for a long handle arrangement, the upper portion 104 of the handle is farthest from the main body 110 or the uppermost handle aperture 128 is aligned with the housing aperture 126 or uppermost housing aperture. The locking pin 130 can then be inserted through the housing and handle apertures 126, 128 to secure the handle in the housing. The locking pin 130 has a ball detent at the inserted end to hold the pin in place in the housing 108 and lower portion 106 of the handle 102 during operation of the pneumatic fastener 100. The upper portion 104 of the handle 102 can also include a gripping portion to be grasped by the user of the fastener. The gripping portion can have a textured surface to help the user hold on to the handle or be formed from a material different from the pneumatic nailer.

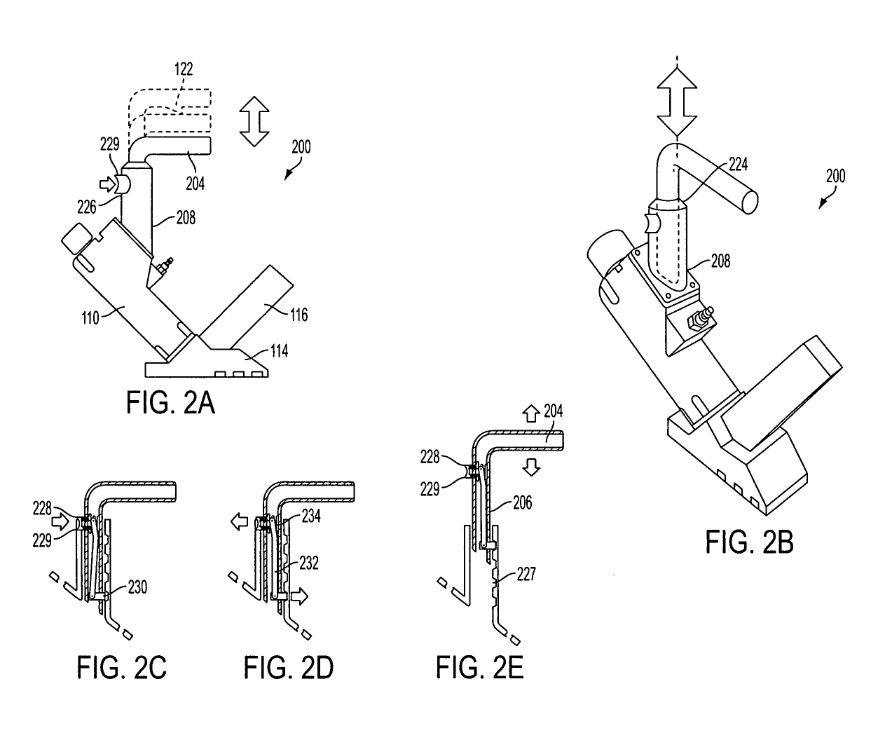

FIGS. 2A-2E illustrate a second embodiment of the present invention. In this exemplary embodiment, the housing 208 of the pneumatic nailer 200 defines a hollow recessed area 224 within which the lower portion 206 of the handle 202 is disposed. The lower portion 206 of the handle 202 is coaxially slidable within the recessed area 224 of the housing 208. A housing aperture 226 is formed through one side of the housing 208 and a plurality of vertically arranged detents or recesses 227 are formed on an opposite side on an internal surface of the housing. A lower handle aperture 228 is formed through a lateral side of the lower portion 206 of the handle 202. The lower handle aperture 228 has, projecting therethrough, a spring-loaded push button 229 that engages and disengages a locking pin 230 as shown in FIGS. 2C-2E. The push button 229 is attached to a spring 234 on an inner surface of the lower portion 206 of the handle 202 laterally opposite to the lower handle aperture 228. The push button 229 is connected through a rotating pivot arm 232 to the locking pin 230. The push button 229 and the locking pin 230 are arranged parallel to each other. FIGS. 2C-2E show that each detent or recess 227 in the housing 208 is configured to receive the locking pin 230 when the push button 229 is released and the rotating pivot arm is inclined toward the lateral side of the lower portion 206 of the handle. The locking pin 230 is activated when the push button 229, which projects through the housing 208 and the lower portion 206 of the handle 202, is depressed. In the disengaged position, the locking pin 230 releases the handle 202 from a fixed position so that the handle can move coaxially along the interior of the housing. Depressing the push button 229 activates the pivoting arm, which rotates about a fixed pivot point and pulls or disengages the locking pin from the recess 227 in the housing 208 allowing the handle to move toward or away from the main body 110. Thus, the push button locking pin with pivot arm allows the handle 202 to be pulled up or extended and pushed down or retracted to a desired length or predetermined height. Releasing the push button 229 at the desired length allows the pin 230 to slide into a recess 227, locking the handle 202 in place.

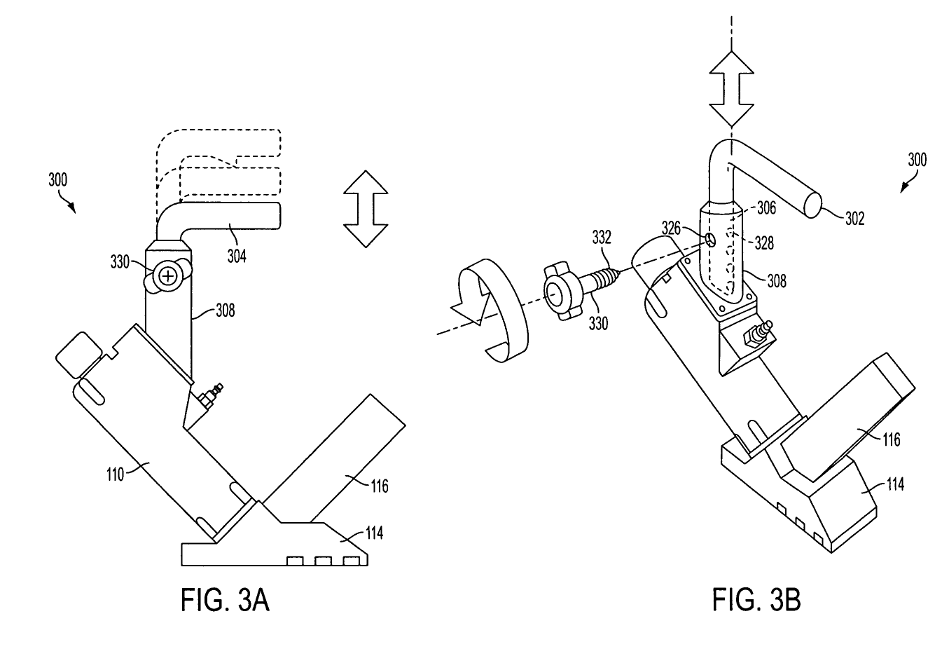

FIGS. 3A and 3B illustrate the third embodiment of the present invention. In this exemplary embodiment, a screw-in fastening knob for adjusting the handle of a pneumatic fastener 300 is illustrated. In this exemplary embodiment, the housing 308 defines a hollow recessed area 324 within which the lower portion 306 of the handle 302 is disposed. The lower portion 306 of the handle 302 is coaxially slidable within the recessed area 324 of the housing 308. A housing aperture 326 is formed through one side of the housing 308. Threaded handle apertures 328 are arranged through the lower portion of the handle 302. In operation, the handle 302 of the pneumatic fastener 300 can be adjusted by aligning the aperture 326 of the housing 308 with at least one of the apertures 328 in the lower portion 306 of the handle. The apertures 328 on the handle 302 are configured to receive a securing member such as a screw-in fastening knob 330. The screw-in fastening knob 330 includes a threaded shaft that can be screwed into the threaded aperture 326 in the housing 308 followed by one of the handle apertures 328, to secure the handle in place. The screw-in fastening knob 330, therefore, prevents the handle from rotating or sliding with respect to the housing. For example, as shown in FIG. 3B, apertures 328 in the lower portion 306 of the handle 302 can be arranged in series, so that the handle can be adjusted to different lengths. Thus, for a short handle arrangement, wherein the upper portion 304 of the handle 302 is closest to the main body 110, the screw-in fastening knob 330 can be inserted into the housing and handle apertures 326, 328 proximal to the main body. Alternatively, for a longer handle arrangement, wherein the upper portion 304 of the handle is farther from the main body 110, the locking pin 330 can be inserted through the lowest vertically arranged handle aperture 328 and the housing aperture 326. As such, the handle 302 can extend from the housing 308 and configured for movement between at least a first position and a second position, different from the first position.

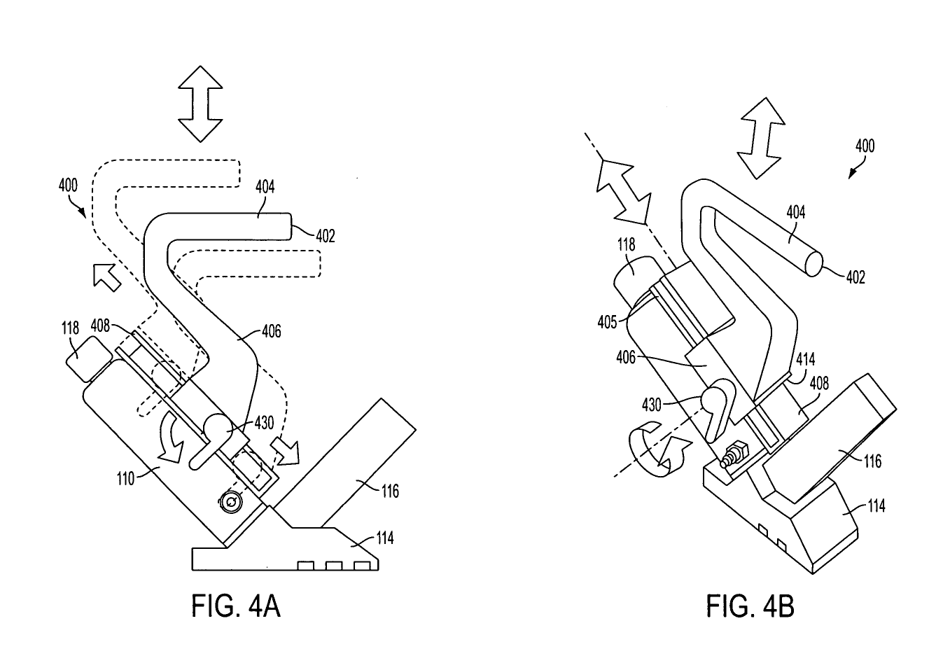

FIGS. 4A and 4B illustrate the fourth embodiment of the present invention. In this exemplary embodiment, FIGS. 4A and 4B illustrate a sliding handle 402 and clamping lever 430 for adjusting the handle of a pneumatic fastener 400. As shown in the figures, the handle 430 is disposed on an inclined supporting member 408 that is mounted on an upper surface of the main body 110. The supporting member 408 has tracks 405 disposed on opposite lateral sides. The tracks 405 run parallel to the upper surface of the main body 110. The tracks 405 slidingly receive the lower portion 406 of the handle 402, which is formed as a grapple having fingers 414. The grapple fingers 414 are disposed within the track 405 for slidingly moving the handle 402 along the length of the inclined supporting member 408. Once the handle 402 is slid to a desired position or predetermined height on the main body 110, the handle can then be clamped by a clamping lever 430 to secure the handle in position. The clamping lever 430 is rotatable in a clockwise or counterclockwise direction. The clamping lever has a cam that engages the interior of track surfaces 405 of the plate 405 and when engaged, prevents the handle from moving. As a result of the present embodiment, sliding the handle toward the striking plunger 118, results in a higher position for the upper portion 404 of the handle, wherein the upper portion 404 of the handle is farther from the main body 110. Alternatively, sliding the handle toward the magazine 116 results in a shorter handle, wherein the upper portion 404 of the handle is closer to the main body 110. As such, the handle 402 is configured for movement between at least a first position and a second position, different from the first position.

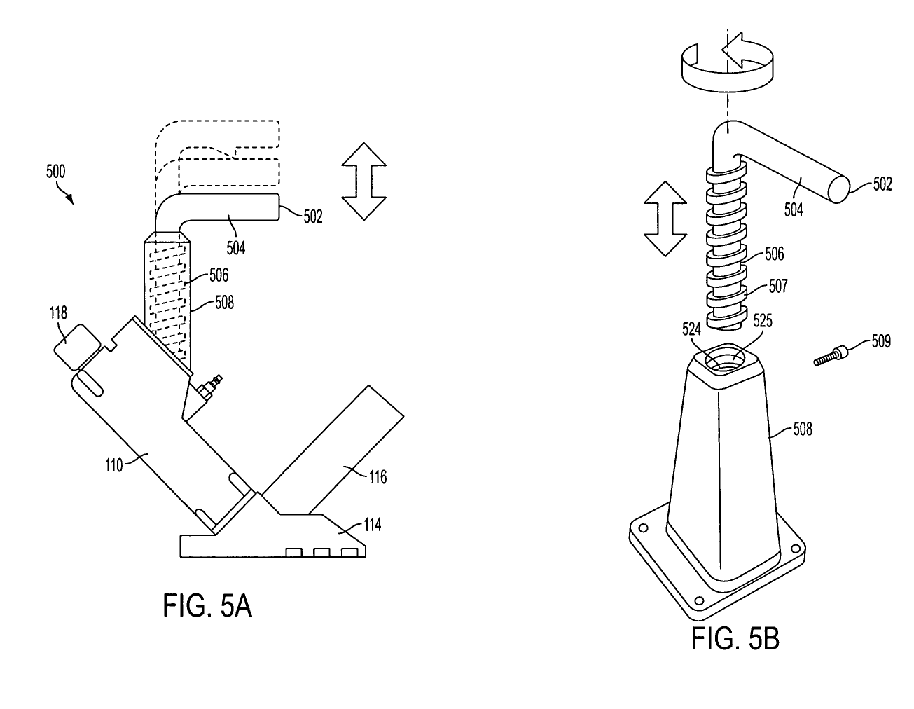

FIGS. 5A and 5B illustrate the fifth embodiment of the present invention. In this exemplary embodiment, FIGS. 5A and 5B illustrate a handle 502 having a 360-degree rotating jackscrew and set screw for adjusting the handle of a pneumatic nailer 500. The housing 508 in FIGS. 5A and 5B defines a recess 524 having threads 525 along the entire inner surface thereof. The lower portion 506 of the handle 502 has jackscrew threads 507 formed on an outer surface thereof, and is movable along the threads 525 within the threaded recess 524 of the housing 508. Rotating the handle 502 releases the jackscrew threads 507 from the threads 525 on the inner surface of the housing 508 so that the handle can move coaxially within the housing 508. As a result, the handle 502 can be positioned for different lengths. The lower portion 506 of the handle 502 also has a narrow vertical slot in the threads for accommodating a set screw 509. The set screw 509 secures the handle 502 in the desired orientation and prevents the handle from rotating. The threaded recess 524 in the housing 508, the threads 507, and the slot can be made by casting.

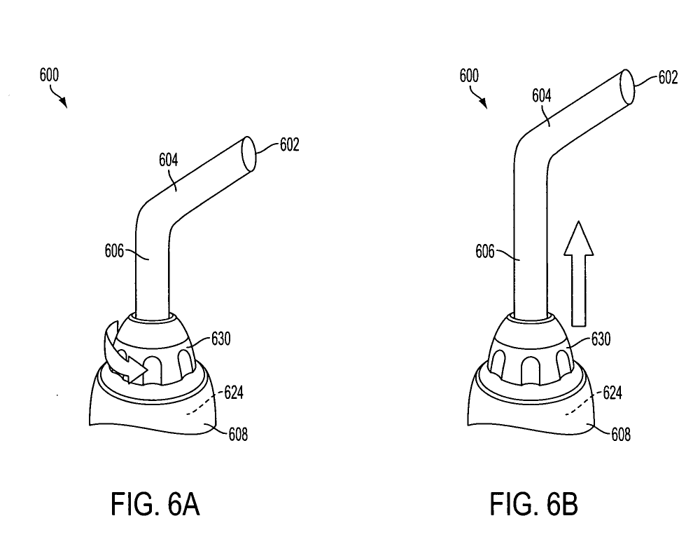

FIGS. 6A and 6B illustrate a sixth embodiment of the present invention. In this exemplary embodiment, FIGS. 6A and 6B illustrate a twist-locking collet assembly 600 that secures the adjustable handle in position on a pneumatic fastener. In this embodiment, the housing 608 defines a hollow recessed area 624, within which a lower portion 606 of the handle 602 is disposed. The lower portion 606 of the handle 602 is coaxially slidable within the recessed area 624 of the housing 608. In operation, the handle 602 of the pneumatic fastener can be adjusted by sliding the handle coaxially within the housing 608. The twist-locking collet 630 is mounted on an outer surface of the handle 602 relative to the longitudinal axis of the lower portion 606 of the handle. The twist-locking collet 630 forms a collar around the lower portion 606 of the handle and exerts a clamping force thereon, when it is tightened by a tapered outer collar. The locking collet fixes the handle in place, thereby preventing the handle from rotating or sliding with respect to the housing. For example, as shown in FIG. 6, the locking collet 630 rotates in one direction to tighten and an opposite direction to loosen, so that the handle can be adjusted to different lengths. Thus, for a short handle arrangement, the collet can be rotated to tighten the handle on the housing when the upper portion 604 of the handle 602 is closest to the main body 110. Alternatively, for a long handle arrangement, the collet can be rotated to tighten when the upper portion 604 of the handle is farthest from the main body 110.

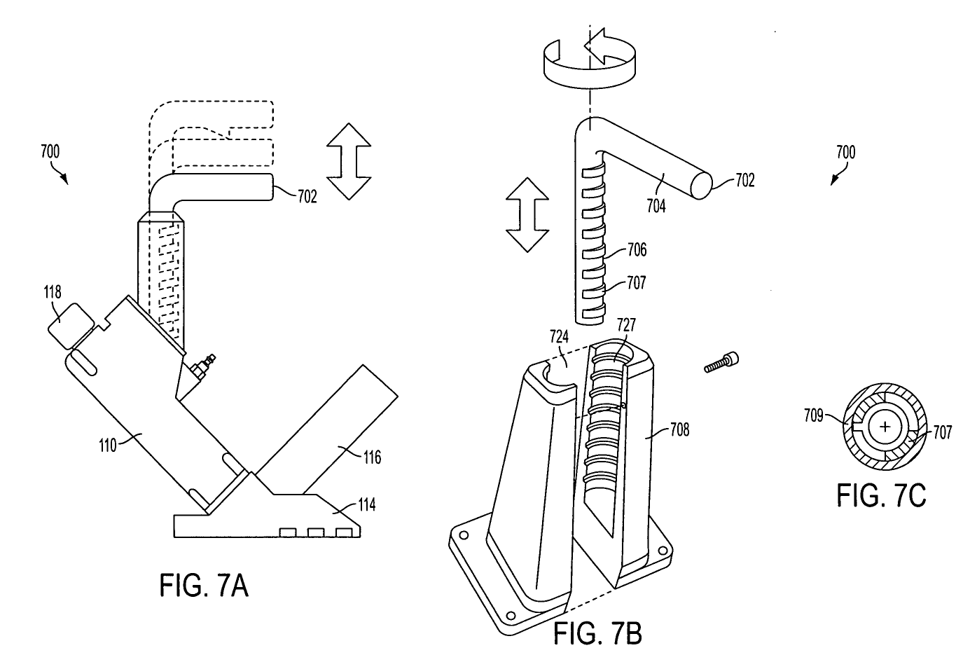

FIGS. 7A-7C illustrate a seventh embodiment of the present invention. In this exemplary embodiment, FIGS. 7A and 7B illustrate a quarter-turn locking handle 702 for adjusting the handle of a pneumatic fastener 700. In this embodiment, the housing 708 defines a recess 724 having ramped cam threads 727 along the entire inner surface thereof. The lower portion 706 of the handle 702 has a ramped cam section 707 on only a 90-degree segment of the surface. The ramped cam section 707 of the handle allows the handle to tighten and loosen along the corresponding ramped cam threads 727 of the housing 708. Rotating the handle 702 90-degrees in one direction, either clockwise or counterclockwise, allows the ramped cam section to be released from the ramped cam section of the housing. As a result, the handle can be adjusted to different positions within the housing 708. FIG. 7C illustrates a cross section through the housing 708 and handle 702. In FIG. 7C, a stop member 709 is provided to stop the rotation of the handle. Thus, by rotating the handle 90-degrees, in one direction, the handle ramped cam section 707 can abut the stop member 709, and thereby be locked in position at different lengths. The threaded recess 724 in the housing 708 and the ramped cam section of the lower portion 706 of the handle can be made by casting.

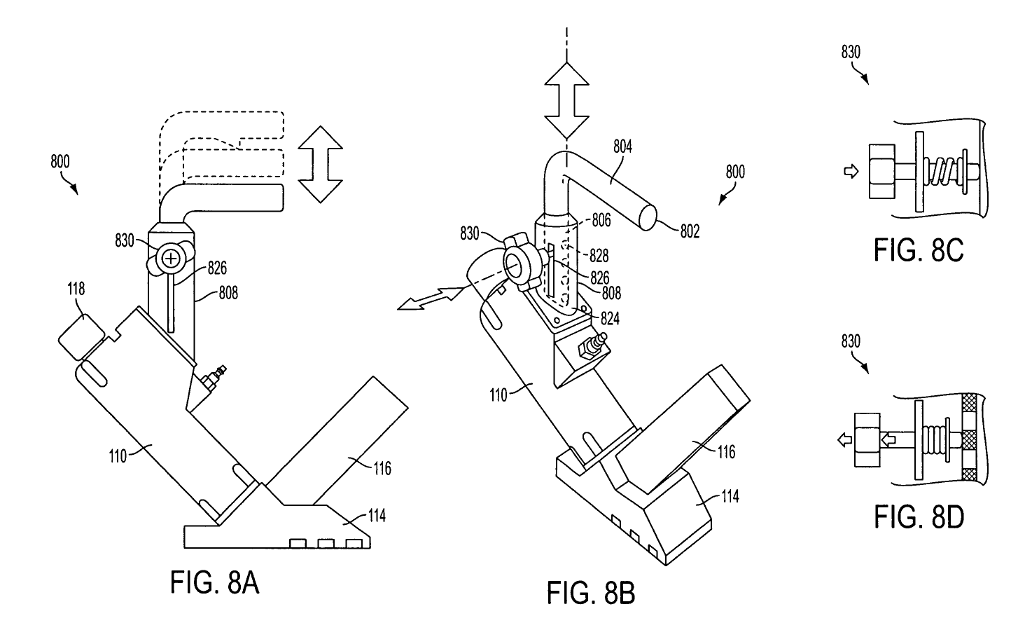

FIGS. 8A-8D illustrate an eighth embodiment of the present invention. In this exemplary embodiment, FIGS. 8A and 8B illustrate a spring-loaded pull-out locking knob pin for adjusting the handle of a pneumatic fastener 800. In this exemplary embodiment, the housing 808 defines a hollow recessed area 824 within which a lower portion 806 of the handle 802 is disposed. The lower portion 806 of the handle 802 is coaxially slidable within the recessed area 824 of the housing 808. A slot 826 is arranged vertically with respect to the main body 110 through at least one side of the housing 808. A plurality of apertures 828 are formed through at least one side of the lower portion 806 of the handle 802 and are configured to receive the locking knob pin 830. In operation, the handle 802 of the pneumatic fastener 800 can be adjusted by releasing the locking knob pin 830 and sliding the handle toward or away from the main body 110, as shown in FIG. 8A. The handle can be secured by aligning the slot 826 of the housing with at least one of the apertures 828 in the lower portion 806 of the handle 802 and inserting the locking pin 830. The locking pin 830 prevents the handle 802 from rotating or sliding with respect to the housing 808. The knob is disposed on an outer surface of the housing while a spring and washer are disposed between the inner surface of the housing and the outer surface of the handle. The spring is larger than the locking pin to keep the locking pin from sliding out of the slot. The locking pin also has a washer disposed at the end to keep the locking pin 830 from separating from the spring. For adjusting the position of the handle 802, the locking pin 830 is disengaged from the apertures 828 in the handle by pulling the knob away from the housing. When the knob is pulled out and the locking pin is disengaged, the handle can be adjusted to a predetermined position.

As shown in FIG. 8B, for example, apertures 828 in the lower portion 806 of the handle 802 can be arranged in series, so that the handle can be adjusted to different lengths. Thus, for a short handle arrangement, wherein the upper portion 804 of the handle 802 is closest to the main body 110, the locking knob and pin 830 can be inserted into the aperture 828 in the handle proximal to the main body. Alternatively, for a long or fully extended handle arrangement, wherein the upper portion 804 of the handle is farthest from the main body 110, the locking knob and pin 830 can be inserted through the lowest vertically arranged aperture of the lower portion 806 of the handle 802.

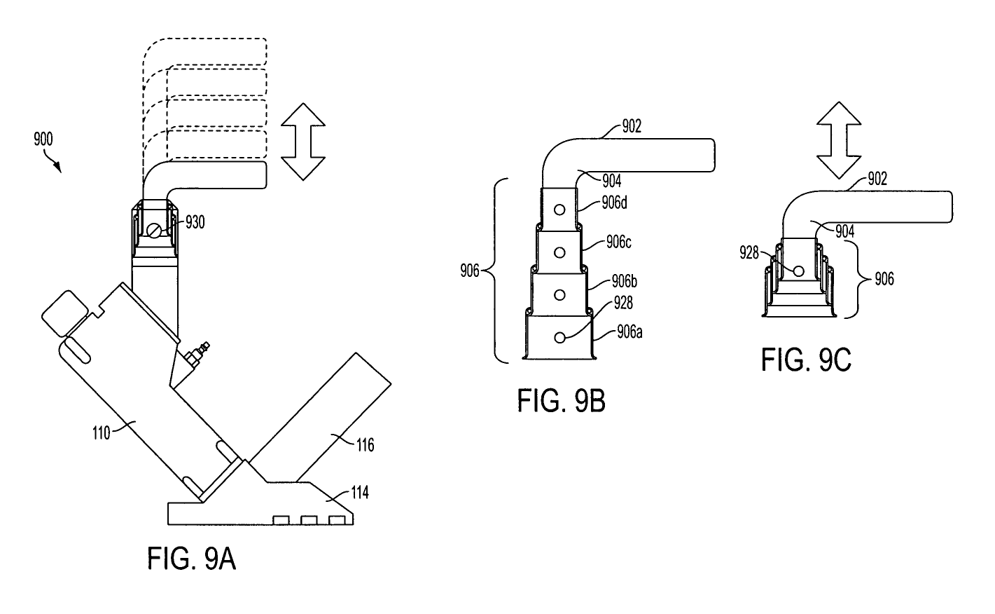

FIGS. 9A-9C illustrate a ninth embodiment of the present invention. In this exemplary embodiment, FIGS. 9A-9C illustrate a telescoping handle for adjusting the position of the handle in the pneumatic fastener 900. As shown in FIG. 9A, the handle 902 has an upper portion 904 and a lower portion 906. The lower portion 906 of the handle 902 can be formed of a plurality of handle segments 906a-906d, for example, arranged by consecutively decreasing diameter, between the main body 110 and the upper portion 904 of the handle. FIG. 9B illustrates the handle at a fully extended position, wherein the telescoping segments 906a-906d are arranged in series. FIG. 9C illustrates the handle at a fully retracted position, wherein the telescoping segments 906a-906d are arranged substantially concentrically. Each telescoping segment includes a threaded aperture 928 through at least one side portion thereof The threaded apertures 928 can be arranged in series. Once the desired handle position is determined, a locking screw 930 is inserted into one or more aligned threaded apertures 928 to secure the position of the telescoping segments.

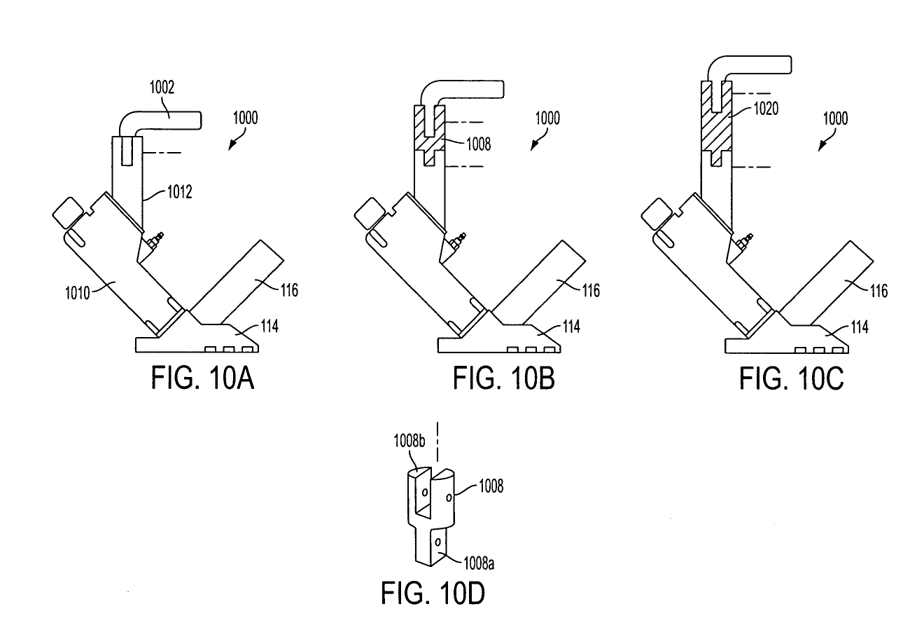

FIGS. 10A-10D illustrate a tenth embodiment of the present invention. In this exemplary embodiment, FIGS. 10A-10D illustrate a removable modular handle insert for adjusting the handle of a pneumatic fastener 1000. As shown, in FIG. 10A, modular handle insert 1012, which can be a part of the housing or separately attached thereto, is mounted onto the main body 1010. The handle 1002 of the pneumatic fastener 1000 can be mounted into housing 1012. FIG. 10B shows a modular handle insert 1008 inserted by a first end 1008a into an aperture on a rear surface of the main body 1010. The handle 1002 of the pneumatic fastener 1000 can be inserted into an opposite second end 1008b of the modular handle insert 1008. The modular handle inserts 1008, 1020 can have different lengths so that the handle 1002 can have different lengths. For example, the modular handle insert 1020 in FIG. 10C is longer than the modular handle insert 1008 in FIG. 10B, so the overall handle is longer. Locking screws 1030 secure the modular handle insert 1008 and the handle 1002 in the desired position. The locking screws (not shown) can be inserted through the handle and modular handle insert to fix the insert 1080 and handle 1002 in position. A single modular handle insert 1008 or 1020 can be used to achieve the desired length. Alternatively, combinations or stacks of modular handle inserts 1008, 1020 can be used together to achieve the desired length.

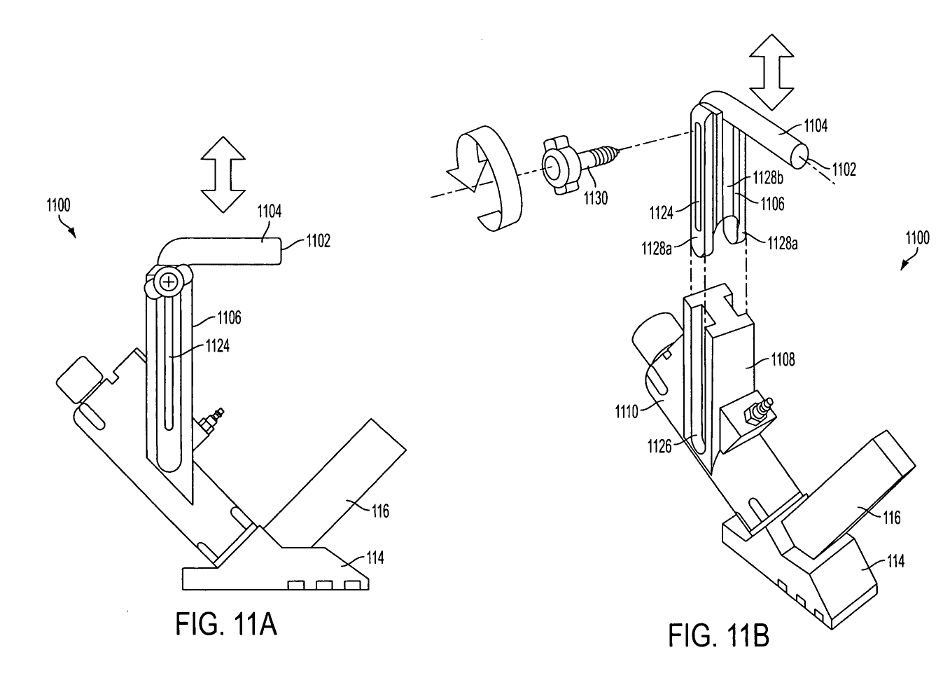

FIGS. 11A and 11B illustrate an eleventh embodiment of the present invention. In this exemplary embodiment, FIGS. 11A and 11B illustrate vertical frame rails and a sliding handle for adjusting the handle of a pneumatic fastener 1100. As shown, a housing 1108 is mounted onto the main body 1110. The housing 1108 has a pair of tracks 1126 on opposite lateral sides thereof. The tracks 1126 are arranged vertically with respect to the main body 1110, along the length of the housing. A handle 1102 is slidingly mounted along the tracks 1126 onto the housing 1108. The handle 1102 has an upper portion 1104 and a lower portion 1106. The lower portion 1106 of the handle 1102 is formed as a pair of opposing parallel arms 1128a that is configured to slide within the tracks 1126 of the housing as shown in FIG. 11B. A third arm 1128b joins the parallel arms 1128a at one end thereof and stabilizes the lower portion 1106 of the handle thereby preventing the arms 1128a from splaying outward. The third arm 1128b also slides along the housing. The lower portion 1106 of the handle 1102 also has a groove 1124 on an outer surface of the parallel arms 1128a. The groove 1124 is configured to receive a locking pin, such as the threaded locking pin 1130 illustrated in FIG. 11B. The threaded locking pin 1130 is adjustable by a knob. The knob is tightened to lock the handle at the desired length.

Although the invention has been described based upon these preferred embodiments, it would be apparent to those skilled in the art that certain modifications, variations, and alternative constructions would be apparent, while remaining within the spirit and scope of the invention.

We claim:

1. A fastener tool comprising:
a base;
a main body mounted to an upper surface of the base, a magazine for storing a fastener mounted on an upper surface of the base and connected to the main body;
a driving mechanism disposed at least partially within the main body for driving the fastener into a workpiece;
a housing having a hollow area mounted on an upper surface of the main body; and
a handle assembly including a handle slidingly arranged within the housing and configured to be secured to the housing.

2. The fastener tool according to claim 1, wherein the handle comprises an upper portion and a lower portion, the lower portion of the handle having at least one handle aperture through a side surface thereof and being disposed within the housing.

3. The fastener tool according to claim 2, wherein the housing comprises at least one housing aperture through a side surface thereof, and the handle comprises a plurality of handle apertures arranged along the length of the lower portion of the handle for alignment with the at least one housing aperture at a predetermined position.

4. The fastener tool according to claim 3, wherein the handle assembly further comprises a securing member insertably arranged through aligned housing and handle apertures and configured to secure the handle and housing in the predetermined position.

5. The fastener tool according to claim 4, wherein the securing member comprises a locking pin.

6. The fastener tool according to claim 4, wherein the securing member comprises a screw-in fastening knob.

7. The fastener tool according to claim 4, wherein the securing member comprises a spring-loaded pull-out locking knob slidably positionable along the length of the housing from a first position proximal to the main body to a second position distal from the main body.

8. The fastener tool according to claim 2, wherein the upper portion of the handle has a gripping portion adapted to be engaged by a hand of a user.

9. The fastener tool according to claim 2, wherein the housing comprises recesses on an internal surface, and the lower portion of the handle assembly comprises a handle adjustment mechanism for engaging the recesses at a predetermined position of the handle.

10. The fastener tool according to claim 9, wherein the handle adjustment mechanism comprises:
a push-button projecting through the handle aperture and connected to a first end of a rotating pivot arm within the lower portion of the handle, and an engaging member configured to be received in the recesses connected to a second end of he rotating pivot arm,
wherein depressing the push button releases the engaging member from the recesses to adjust the handle to a predetermined position and releasing the push button fixes the engaging member in the recesses to secure the handle in the predetermined position.

11. The pneumatic fastener of claim 1, wherein the housing is generally cylindrical.

12. A fastener tool comprising:
a base;
a main body mounted to an upper surface of the base,
a magazine for storing a fastener mounted on an upper surface of the base and connected to the main body;
a driving mechanism disposed within the main body for driving the fastener into a workpiece;
a supporting member mounted on an upper surface of the main body; and
a handle assembly slidingly arranged along an upper surface of the supporting member and configured to be secured thereto.

13. The fastener tool according to claim 12, wherein the supporting member comprises a pair of tracks on opposite lateral sides thereof

14. The fastener tool according to claim 13, wherein the handle assembly comprises fingers at least partially disposed in the pair of tracks for slidably moving the handle assembly along the supporting member.

15. The fastener tool according to claim 12, wherein the handle assembly further comprises a clamp for clamping the handle assembly to the supporting member in a predetermined location.

16. The fastener tool according to claim 12, wherein slidably moving the handle assembly along the supporting member in a first direction increases the height of the handle with respect to the base and slidably moving the handle assembly in a second direction decreases the height of the handle with respect to the base.

17. The fastener tool according to claim 12, wherein the supporting member is inclined on the upper surface of the main body.

18. A fastener tool comprising:
a base;
a main body mounted to an upper surface of the base,
a magazine for storing a fastener mounted on an upper surface of the base and connected to the main body;
a driving mechanism disposed within the main body for driving the fastener into a workpiece;
a housing having a hollow recessed area mounted on an upper surface of the main body; and
a handle assembly rotatably arranged within the housing and configured to be secured to the housing.
